(19) United States
(12) Patent Application Publication
(10) Pub. No.: US 2020/0233196 A1
(43) Pub. Date: Jul. 23, 2020

(54) MICROSCOPY ARRANGEMENT WITH MICROSCOPE SYSTEM AND HOLDING APPARATUS, AND METHOD FOR EXAMINING A SPECIMEN WITH A MICROSCOPE

(71) Applicant: Leica Microsystems CMS GmbH, Wetzlar (DE)

(72) Inventors: Werner Knebel, Kronau (DE); Volker Leimbach, Ilvesheim (DE); Roland Seifert, Heidelberg (DE)

(21) Appl. No.: 16/639,153

(22) PCT Filed: Aug. 16, 2018
(86) PCT No.: PCT/EP2018/072270

§ 371 Date: Feb. 14, 2020

(30) Foreign Application Priority Data
Aug. 18, 2017 (DE) 10 2017 118 850.9

(51) Int. Cl. G02B 21/06; G02B 21/00; G02B 21/18; G02B 21/26

(52) U.S. Cl. CPC G02B 21/06; G02B 21/26; G02B 21/18; G02B 21/0032

(57) ABSTRACT

A microscopy arrangement includes a holding apparatus having an instrument platform, a holding element which is rigidly connected thereto and to a microscope and a support element configured to support the instrument platform on a main platform at a distance therefrom. In a vertical projection, the holding apparatus at least does not completely overlap with the microscope supported by the holding element. The support element has a changeable height such that the instrument platform is positionable at a changeable vertical distance from the main platform and/or a height-changeable microscope stage places an object plane that is defined by the microscope stage at a changeable vertical distance such that a vertical extent of an object region is changeable. The laser beams remain in a fixed relationship with one another in time and/or space, even in the case of a change in the vertical extent of the object region.

### CROSS-REFERENCE TO PRIOR APPLICATIONS

This application is a U.S. National Phase Application under 35 U.S.C. § 371 of International Application No. PCT/EP2018/072270, filed on Aug. 16, 2018, and claims benefit to German Patent Application No. DE 10 2017 118 850.9, filed on Aug. 18, 2017. The International Application was published in German on Feb. 21, 2019 as WO 2019/034751 under PCT Article 21(2).

### FIELD

The present invention relates to microscopy arrangement comprising a microscope system and holding apparatus, in particular for multi-photon microscopy and/or for multicolor multi-photon applications and/or CARS experiments, and to a method for examining a sample using a microscope.

### BACKGROUND

Microscopy arrangements for multicolor multi-photon applications frequently require that a plurality of laser beams be coupled into a microscope in such a way that the input coupled laser beams have a fixed relationship with respect to one another in time and space. Here, use can be made of a cascaded arrangement, in which the various laser beams are successively coupled into the microscope system with spatial overlap with one another. Usually, a separate beam adaptation must be carried out for each laser beam, for the purposes of which, for example, a beam diameter and/or a divergence and/or a dimension and/or position of the focus must be set separately for each laser beam such that the laser beams have the desired properties and, in particular, the desired relationship with respect to one another in time and/or space. By way of example, such beam adaptations can be implemented by hand and/or in partly or completely automated fashion.

Changes in the height of the microscopy arrangement, i.e., a change in the distance between objective and object, may be required or advantageous, for example, in order to be able to carry out measurements of differently sized objects, for example examinations of the eye of a mouse or the eye of a monkey, by means of the microscopy arrangement. However, when changing the height of the microscopy arrangement or the distance from the objective to the object, a corresponding adaptation of the beam guidance length of the laser beams is usually also required, for the purposes of which optical elements such as mirrors and/or optical lenses, for instance, frequently have to be exchanged and/or displaced, and/or a beam expansion and/or a beam divergence must be adapted. Frequently, this requires a large number of different optical elements and, moreover, such an adaptation of the microscope system to the modified beam guidance length requires significant adjustment outlay.

DE 10 2011 115 944 A1 relates to a nonlinear laser scanning microscope for flexible noninvasive three-dimensional detection of tissue. Here, illumination light is guided into a measuring head via a (mirror) articulated arm and one or more optical fibers. The alignment of the measuring head is freely adjustable by means of the flexible arm. In this way, the measuring head can be directed onto the tissue to be examined, for example in a human. However, a mouse to be examined is situated on a separate platform directly under the measuring head in this case. Depending on the size of the object to be examined, use is consequently made of platforms at different heights. Moreover, a beam stabilization is situated in the measuring head because the beam position can be shifted as a result of the change of the position of the measuring head. Here, the beam must be repositioned following the movement of the arm. To this end, movable mirrors that guide the beam back into the center are controlled.

US 2005/0187441 A1 likewise describes a laser scanning microscope for examining tissue. This laser scanning microscope comprises a horizontal base and a vertically extending limb with a slider, wherein the scanning head fastened to an arm can be displaced upward and downward by means of the slider. The light of an external laser light source is guided into the scanning head via an optical fiber. An optical detector is connected to the scanning head.

EP 1 757 969 A1 describes a microscope movement device for a microscope with a large object space. A laser as an illumination light source is located on a main platform in this case. The light beam is guided along two arms into the microscope via mirrors. The entire structure is rotatable about the optical axis of the laser beam.

US 2004/0223213 A1 describes a combination of a microscope with a large magnification and a microscope with a small magnification, wherein the latter is used as an auxiliary microscope for maintaining an overview during the examination. Both microscopes are coupled in such a way that their fields of view are exactly overlaid. A continuous (argon) laser light source, whose laser beam is input coupled using a glass fiber, serves as a light source for the microscope with a large magnification. By way of example, a laser pointer, whose laser beam is likewise input coupled using a glass fiber, serves as a light source for the auxiliary microscope.

In addition to input coupling of laser beams by means of optical fibers or by means of reflective optical elements (mirrors), the practice of fastening the laser directly to the height-adjustable housing is also known. Thus, JP H06 51 204 A relates to a flexible microscope system that can be constructed in modular fashion. The lamp housing of this microscope system can be fastened directly to the tube of the microscope. A similar configuration is disclosed by DE 198 32 319 A1, which describes an inverted microscope, fastened to the limb of which there are two illumination sources, specifically a transmitted light illumination system and a mercury vapor lamp for reflected light illumination.

The starting point of the present invention lies in the use of powerful multi-photon lasers for a microscopy arrangement. These multi-photon lasers can be operated over a large spectral range, and have large dimensions (e.g., 50 cm×100 cm) and a correspondingly large weight. Typically, many structures require two such lasers, which must then be adjusted in the same focal range. Guiding the light from such multi-photon lasers via an optical fiber is not conceivable for numerous reasons. The power supplied by such multi-photon lasers lies in the range of several watts and leads to the destruction of the input coupling surface of the optical fiber in the case of a slight maladjustment thereon. Likewise, very small dust particles in the focusing range on the fiber already lead to the destruction of the front region of the fiber. A further reason lies in the dispersion of the fiber, which leads to a pulse broadening of the laser light. Complicated pulse compressions would subsequently be required to bring the laser pulses back into the desired fs-range. The complicated pulse compression is additionally accompanied by a loss of light.

For the examinations considered here, a separate beam adaptation must be carried out for each laser, comprising the setting of different beam diameters and divergences and the adaptation or the displacement of the different focuses, possibly also in automated fashion. Moreover, the employed objectives demand different beam adaptations. If an attempt were made to also change the beam guidance length as well by virtue of changing the height of the microscope structure for the purposes of examining objects of changeable size, use would have to be made of new optics for beam expansion and beam divergence. This not only requires that optical components be exchanged but also additional calibration steps, as a result of which the installation of the system is made significantly more difficult.

In the above-described prior art, this problem is either circumvented by virtue of the laser being attached to the height-adjustable housing of the microscope and/or by virtue of the laser light being coupled into the microscope by way of an optical fiber. The use of an optical fiber is eliminated for the aforementioned reasons. However, on account of the large weight of multi-photon lasers and the unwieldiness of same, these cannot be attached to the housing of a microscope either, particularly if the housing is intended to be moved mechanically.

### SUMMARY

In an embodiment, the present invention provides a microscopy arrangement including a microscope system and a holding apparatus. The microscope system includes a microscope and an illumination device comprising at least two lasers configured to produce laser beams and input coupling elements configured to input couple the laser beams into the microscope. The holding apparatus includes an instrument platform on which the at least two lasers of the illumination device are disposed, a holding element which is rigidly connected to the instrument platform and to the microscope and at least one support element configured to support the instrument platform on a main platform and at a distance from the main platform. In a vertical projection, the holding apparatus at least does not completely overlap with the microscope supported by the holding element. A region between the microscope and the main platform forms an object region. The at least one support element has a changeable height such that the instrument platform is positionable at a changeable vertical distance from the main platform and/or a height-changeable microscope stage is configured to dispose an object plane that is defined by the microscope stage at a changeable vertical distance from the main platform such that a vertical extent of the object region is changeable. As a result of the foregoing features, the at least two laser beams remain in a fixed relationship with one another in time and/or space, even in a case of a change in the vertical extent of the object region.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 shows a schematic illustration of a microscopy arrangement according to a first preferred embodiment.

FIG. 2 shows a perspective illustration of a microscopy arrangement according to a second preferred embodiment.

FIG. 3 shows, in a plan view, a detail of the input coupling of the laser beams in the case of a microscopy arrangement according to an embodiment of the invention.

### DETAILED DESCRIPTION

Embodiments of the present invention provide a microscopy arrangement and a method for microscopic examination by means of such a microscopy arrangement, which microscopy arrangement offers greater flexibility in respect of the usable object region or object distance and, in particular, requires no readjustment of the laser input coupling, where possible, when changing the size of the object region or the object distance.

The microscopy arrangement according to an embodiment of the invention comprises a microscope system and a holding apparatus. The microscope system comprises a microscope and an illumination device comprising at least two lasers, in particular multi-photon lasers, and input coupling elements for input coupling each of the laser beams produced by the at least two lasers into the microscope, in particular into an illumination beam path of the microscope, in particular into a scanning head of the microscope. The holding apparatus comprises an instrument platform, on which the at least two lasers of the illumination device are disposed, a holding element, which is rigidly connected, firstly, to the instrument platform and, secondly, to the microscope of the microscope system, and at least one support element which is designed to support the instrument platform on a main platform and at a distance from the latter. Here, the microscopy arrangement is embodied in such a way that, in a vertical projection, the holding apparatus at least does not completely overlap with the microscope supported by the holding element, and so a region between the microscope and the main platform forms an object region. Furthermore, the at least one support element has a changeable height in order to dispose the instrument platform at a changeable vertical distance from the main platform. As an alternative or in addition thereto, the microscope system comprises a height-changeable microscope stage in order to dispose an object plane that is defined by the microscope stage at a changeable vertical distance from the main platform. As a result of these two measures, the vertical extent of the object region is changeable. The microscopy arrangement according to an embodiment of the invention is embodied to the effect of the at least two laser beams coupled into the microscope remaining in a fixed relationship with one another in time and/or space, even in the case of a change in the vertical extent of the object region.

The microscopy arrangement according to an embodiment of the invention comprises an illumination device comprising at least two lasers, in particular multi-photon lasers or, in general, lasers that are not couplable into the microscope via optical fibers. Usually, “multi-photon lasers” denotes mode-coupled short pulse lasers with pulse repetition frequencies in the MHz range and pulse widths in the range of a few femtoseconds (fs) to a few picoseconds (ps), which are used for multi-photon microscopy experiments. A frequently employed multi-photon laser is a mode-coupled titanium-sapphire (Ti:Sa) laser, which has a large tuning range of 700-1050 nm and which supplies pulse widths of less than 100 fs with a pulse repetition frequency around 80 MHz. Optical elements known per se are present as input coupling elements and serve to couple the laser light emitted by the aforementioned lasers into the microscope. For the reasons set forth at the outset, the input coupling elements comprise no optical fibers in this case. Rather, these substantially relate to reflective and/or partly reflective and/or collimating and/or focusing and/or defocusing optical components, such as deflection means and lenses. Diffractive optical elements (DOEs), too, and also the combination of diffractive and refractive optical components can be placed in the beam path. This renders specific beam shaping and color corrections adjustable. Use can also be made of adaptive optical units such as spatial light modulators (SLMs), by means of which both the phase and the amplitude of the light can be spatially changed. Likewise, a variable adaptation of the illumination light at different sample depths can be achieved thereby.

The illumination device may comprise further additional lasers, such as continuous wave or pulsed lasers, for example in the visible range, wherein these additional lasers, in particular visible CW lasers, may also be coupled into the microscope via optical fibers as a matter of principle. Pulsed lasers in the UV range, which usually supply high pulse energies and pulse repetition frequencies in the kHz range, may serve as a further light source. Such lasers likewise cannot be couplable into the microscope via optical fibers. Such lasers often serve to ablate biological material (destroy or remove biological material).

The instrument platform of the holding apparatus of the microscopy arrangement according to an embodiment of the invention is preferably embodied as a planar platform or slab, which is accessible from all sides in order to be able to easily dispose and adjust the aforementioned lasers and the associated input coupling elements. After this adjustment, in particular, the instrument platform may also be at least partly surrounded by a housing for protection purposes. As explained below, for the further examinations in the case where the object region has changed its size, the at least two lasers and the corresponding input coupling elements can remain unchanged in terms of their arrangement following the first adjustment since no new adjustment is required in this case.

The holding element is rigidly connected both to the instrument platform and to the microscope; expressed differently, the corresponding connections between the holding element and instrument platform and also between the holding element and microscope have an unmovable and non-adjustable embodiment. The holding element can be fastened directly or immediately at the instrument platform, or indirectly via other components. As a result, the microscope is supported by the holding element in such a way that the microscope has a permanently secured spatial arrangement relative to the instrument platform. Consequently, relative movements, in particular unwanted relative movements, between the microscope and instrument platform, and hence the at least two lasers situated on the instrument platform, which would impair the coupling of the corresponding laser beams into the microscope, are precluded. This does not prevent individual components of the microscope or of the microscope system from having a movable embodiment provided a movement of these movable components does not impair the coupling of the laser beams produced by the at least two lasers into the microscope.

The phrasing “an instrument platform” and “a holding element” is non-restrictive; instead, it also comprises the presence of a plurality of instrument platforms or plurality of holding elements.

By way of example, the at least one support element can be embodied as a base, a pillar, a post, a supporting wall and/or a column. In particular, the at least one support element can also be configured in such a way that it partly or completely fills the space between the instrument platform and the main platform. Furthermore, the region around the at least one support element can be completely encased, and so it acts like a housing to an observer. The support element or elements carrying or supporting the instrument platform may have a fixedly predetermined height, i.e., extent in the vertical direction, or else a changeable height. In particular, it is also possible to use support elements of a fixed height, which are selected from a supply of support elements with different fixed heights. In this way, the instrument platform can be disposed at different vertical distances from the main platform by replacing support elements, in order to produce differently high object regions. For the actual microscopic examination, the instrument platform should be spaced apart from the main platform as rigidly and as immovably as possible.

The aforementioned vertical projection refers to a two-dimensional projection into a horizontal plane, wherein the vertical direction, as generally conventional, is directed perpendicular to the surface of the Earth and hence, in particular, also perpendicular to the main platform and preferably likewise substantially parallel to the optical axis of the microscope. In a plan view from a vertical direction, the microscope supported by the holding element does not, or at least not completely, overlap with the holding apparatus itself, and so an object region that is freely accessible for positioning and examining an object to be examined remains.

Consequently, the object region forms the region in which an object to be examined by the microscope of the microscopy arrangement can be disposed. Particularly in the case of support elements with a fixed height for reducing the object region in the vertical direction, a microscope stage may be present to place the object to be examined on an object plane, usually the surface of the microscope stage or parallel thereto. In this case, the object region extends between the object plane and the microscope or the microscope objective in the vertical direction. Alternatively, the object to be examined can also be placed directly on the main platform below the microscope, and so the object region substantially extends between the main platform and the microscope objective in the vertical direction. Preferably, the vertical extent of the object region is changeable in order to be able to house large and small objects, in particular also living objects, there in a simple manner. This achieves sufficient flexibility of the objects to be examined in respect of their spatial dimensions and/or spatial arrangement. Moreover, other auxiliary means may be disposed in the object region in addition to the objects to be examined, for example laboratory jacks, also referred to as “lab jacks”, which correspond to the aforementioned microscope stage in order, for instance, to be able to dispose the object at a desired position in the vertical direction relative to the microscope objective, and/or a hot plate and/or a head holder for human and/or animal objects and/or monitoring instruments, for instance a pulse measuring device.

According to an embodiment of the invention, two or more lasers can be combined in interference-free fashion and can remain stable in terms of their position with respect to one another, both in time and space. As a result of the construction in two planes, specifically an instrument platform and a main platform, a stable beam path is ensured even over large distances since the optical structure in the optics plane of the instrument platform and the elements securely (rigidly) connected therewith remain constant and only the object plane is adapted to the experimental conditions by virtue of using the main platform as such or with a laboratory jack situated thereon for the purposes of positioning the object to be examined. The laser beams are superimposed in space and time on the instrument platform and subsequently coupled into the microscope directly, i.e., without optical fibers that could change the beam profile and/or the temporal superposition, such that a high long-term stability is ensured. By contrast, the effects on account of a Z-adjustment of the objective for focusing are minimal or neglectable.

Embodiments of the invention offer the advantage of the microscope remaining in a fixed spatial arrangement with respect to the lasers situated on the instrument platform, even if the specified object region is changed for the purposes of examining objects of different sizes. What can be achieved by the microscopy arrangement according to an embodiment of the present invention is that a change in the height or the vertical distance between the main platform and the objective of the microscope can be implemented without having to exchange optical elements in the process and/or without having to change or readjust input coupling and/or provision of laser beams into the microscope by way of the illumination device. Thus, an embodiment of the invention offers the advantage that a microscopy arrangement with a flexible object region can be provided, in which the outlay for readjustment and/or adaptation of optical elements, such as input coupling elements or other elements of the illumination optical unit, is significantly reduced or even entirely dispensed with in relation to conventional systems. In this way, the outlay for the user and for servicing staff for microscopy arrangement servicing can be significantly reduced and hence it is possible to save work in time and/or costs in relation to the use of conventional systems.

Moreover, an embodiment of the invention offers the advantage that the microscopy arrangement can be disposed, for example, on a conventional optical table, in particular an anti-vibration table, as a main platform, and that consequently it can be integrated with little additional outlay in a conventional optics laboratory.

In addition to the aforementioned option of using support elements of a predetermined height, which, in particular, are selected from a supply of support elements of different heights, the at least one support element can preferably have a changeable height in order to dispose the instrument platform at a changeable vertical distance from the main platform and consequently dispose the microscope at a changeable vertical distance from the main platform or from a differently defined object plane. In the case of the change in the vertical extent of the object region resulting in this case, the microscope remains in a fixed spatial arrangement with respect to the instrument platform, and so the at least two laser beams that are coupled into the microscope remain in a fixed relationship with one another in time and/or space. Preferably, the holding apparatus comprises a drive element, which is configured to change the height of the support element or elements. In this way, the height of the object region can be changed in automated fashion.

Preferably, the holding apparatus comprises a plurality of support elements. For reasons of stability, it is advantageous if the arrangement comprises at least two, three, four or even more support elements. Moreover, the pressure of the instrument platform on the main platform can be distributed more uniformly by using a plurality of support elements. This is particularly advantageous if use is made of a main platform that is embodied as an antivibration table. In the case of a more uniform distribution of the pressure on such an antivibration table, which comprises a hydraulic and/or pneumatic damping system, for example, one-sided loads can be avoided, the load-bearing capacity can be increased and the wear can be reduced.

Expediently, the at least one support element has a height of at least 1 mm, 1 cm, 5 cm, or, more preferably, 12 cm or 40 cm. Secondly, the height should be no more than 5 m, 2 m, 1 m, 75 cm, or, more preferably, no more than 50 cm. An analogous statement applies to the height adjustment range of height-changeable support elements.

The microscope stage or the laboratory jack is preferably disposed on the main platform in order to easily adapt the object spacing to a desired height. The dynamics of the adjustment region, but also the accuracy of the adjustment, can be further increased by a combination of the height-adjustable microscope stage and the height-adjustable support elements.

Furthermore, another embodiment of the invention provides a method for examining a sample using a microscope in a microscopy arrangement according to an embodiment of the invention, wherein, following the coupling of each of the laser beams produced by the at least two lasers into the microscope, the sample is examined using the settings, already made, for coupling the laser beams into the microscope, even if the vertical extent of the object region is changed prior to an examination by changing the height of the at least one support element and/or by changing the vertical distance of the object plane from the main platform by means of the height-changeable microscope stage or laboratory jack.

In respect of the advantages and further configurations for the method according to embodiments of the invention, reference is made, in the entirety thereof, to the aforementioned explanations relating to the microscopy arrangement according to embodiments of the invention.

It should be stressed, once again, that no glass fibers are used as input coupling elements of the laser beams into the microscope, for at least as long as this does not relate to the laser beams of additional lasers.

It is understood that the features specified above and the features yet to be explained below are usable not only in the respectively specified combination but also in other combinations without departing from the scope of the present invention. This applies, in particular, to features disclosed in conjunction with the following figures.

The invention and its advantages are explained in more detail below on the basis of exemplary embodiments in the drawings.

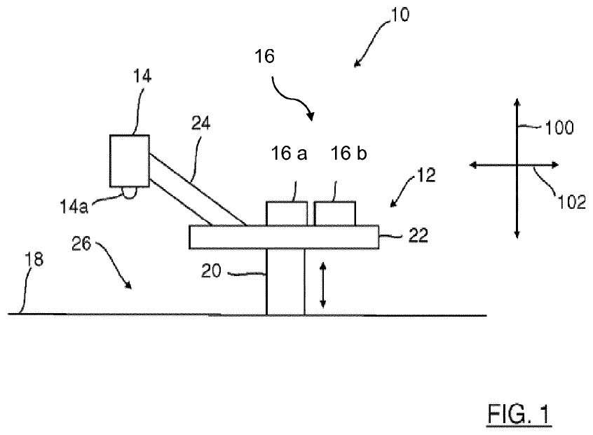

FIG. 1 shows a schematic illustration of a microscopy arrangement 10, which comprises a microscope system and a holding apparatus 12. Here, the holding apparatus 12 supports the microscopy system, the microscopy system comprising a microscope 14 and an illumination device 16, which may consist of a plurality of parts. By means of the holding apparatus 12, the microscope system is disposed over a main platform 18 in such a way that the microscope 14 is positioned vertically over the main platform 18 at a predetermined and/or changeable distance. Here, the vertical direction is denoted by the arrow 100 and the horizontal direction is denoted by the arrow 102.

According to the shown preferred embodiment, the holding apparatus 12 comprises (at least) one support element 20, which carries the instrument platform 22 on which the illumination device 16 is disposed and/or fastened. According to the shown preferred embodiment, the support element 20 has a variable configuration in terms of its height or length so as to move or displace the instrument platform 22 and hence the holding element 24, on which the microscope 14 is fastened, in the vertical direction. The holding element 24 is fastened to the instrument platform 22 in rigid fashion and unchangeable in terms of its spatial alignment, and it is fastened to the microscope 14 in the same way. The holding apparatus 12 is embodied in such a way that a fixed and unchanging spatial relationship between the instrument platform 22 and the microscope 14 is maintained, even during the displacement or the movement of the instrument platform 22.

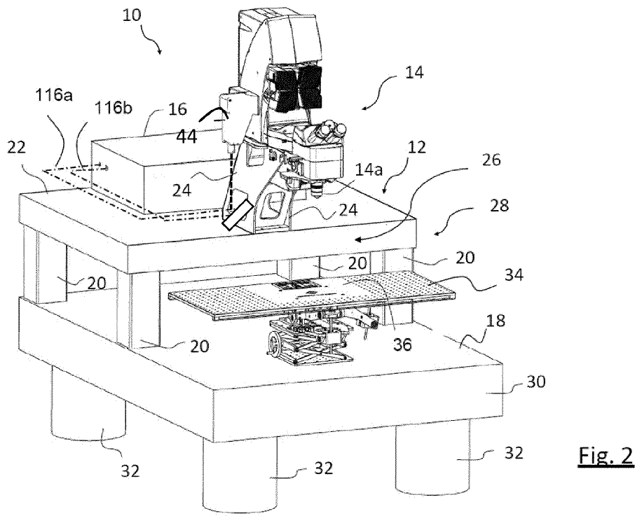

Here, the microscopy arrangement 10 is configured in such a way that an object region 26 is present below the microscope 14 or the objective 14a of the microscope 14, an object to be examined being able to be disposed on the main platform 18 under the objective 14a in said object region for the purposes of a microscopic examination. As a result of the height-adjustability of the microscopy arrangement 10, objects of different sizes can be examined by the microscopy arrangement 10 in particularly advantageous fashion, wherein, for example in the case of particularly small objects, the vertical distance of the microscope 14 from the object can be reduced further by arranging a microscope stage, in particular a height-adjustable microscope stage, or laboratory jack on the main platform 18 (cf. FIG. 2).

Here, the microscope system is configured in such a way that the illumination device 16 comprises a plurality of lasers 16a, 16b, in particular multi-photon lasers and/or other lasers that are not couplable into the microscope 14 by optical fibers, such as pulsed UV lasers, the emitted laser beams of which are coupled into the microscope 14 by means of input coupling elements. As a result of the holding element 24 and the instrument platform 22 having a fixed and unchanging spatial relationship with respect to one another, even if the height of the object region 26 is changed by means of the variable support element 20, no adaptation and/or readjustment and/or exchange of optical elements is required for input coupling of the laser beams, even during and/or after a height adjustment, since the optical beam path of the input coupled laser beams can be maintained unchanged.

In one possible application, use is made of two multi-photon lasers 16a, 16b, which are synchronized in time and which are adjusted in such a way that both wavelengths are incident in the same focal volume of the object region 26. The lasers can generate different signals: depending on the excitation wavelengths, it is possible to excite different fluorochromes for two-photon emission (TPE); there could also be two-color two-photon excitation (2C-TPE), where a fluorochrome simultaneously absorbs respectively one photon from each excitation laser and subsequently emits a fluorescence signal. The detection of the two fluorescence signals is implemented simultaneously, for example both by way of the intensity signal and by way of the lifetime signal (FLIM, gated FLIM) or else by way of time-correlated single photon counting (TCSPC). In the case of processes that are very quick in time, the fluorochrome emissions cannot be recorded sequentially, and so the detection data must be generated simultaneously. Since the two laser lines arrive simultaneously in the focal volume, fast detection electronics that are synchronized to one of the two laser lines can record the decay kinetics of the fluorochromes. If the lifetimes of the fluorochromes differ by several hundred picoseconds, the signals can be presented separately from one another. A timestamp is generated, and subsequently assigned, in the detection electronics for each incident detected photon.

It is also possible to implement a series connection of two multi-photon lasers, which are synchronized by way of a so-called delay stage. Both beam paths can be adapted in terms of their beam divergence.

FIG. 2 shows a perspective illustration of a microscopy arrangement 10 according to a second preferred embodiment. According to this preferred embodiment, the holding apparatus 12 comprises four support elements 20. The holding apparatus 12 comprises the holding element 24, which comprises two arcuate arms on which the microscope 14 is fastened and as a result of which the microscope 14 is held over the object region 26.

At the side on which the holding element 24 is formed, the instrument platform 22 has a cutout 28 or, in general, said platform is kept shorter than the main platform 18 in the horizontal direction in order to enlarge the object region 26 and in order to prevent the object or the object region 26 form being concealed or covered by the instrument platform 22.

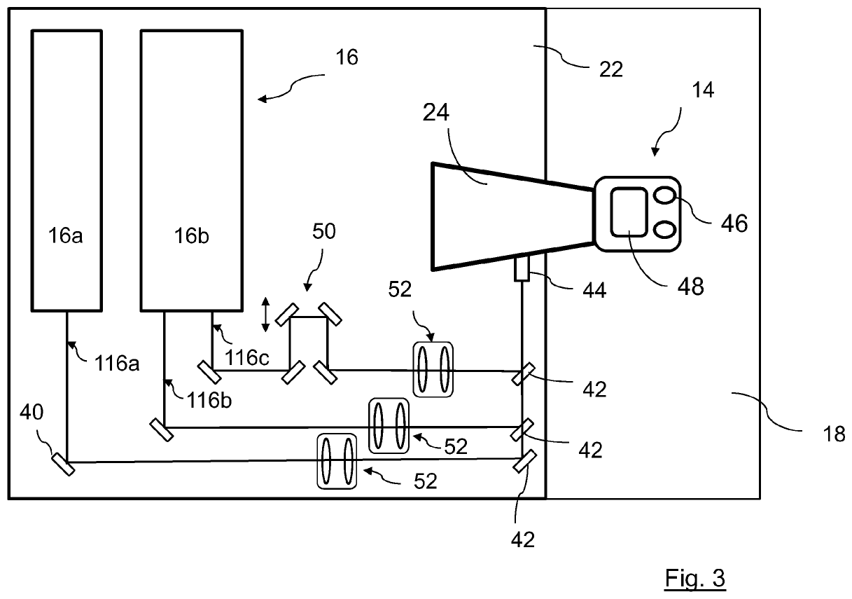

The illumination device 16 is disposed on the instrument platform 22; according to the shown embodiment, said illumination device emits two multi-photon laser beams 116a and 116b, which are schematically illustrated by the dash-dotted lines. The laser beams 116a and 116b are input coupled into the microscope 14, more precisely into the scanning head of the microscope 14 via the input coupling port 44 and via a deflection element, at the instrument platform 22 or at the holding element 24 by means of input coupling elements (cf. FIG. 3) comprising a mirror illustrated here and said laser beams are consequently available for fluorescence measurements in the object. To this end, different dichroic mirrors are driven in motor-driven fashion by way of a beam splitter slider or a beam splitter wheel within the scanning head.

According to the shown embodiment, the instrument platform 22 is carried by four support elements 20. Here, these support elements 20 have a rigid embodiment and therefore cannot be varied in terms of their height. Preferably, the height of the support elements 20 is chosen from a supply of support elements of different heights in such a way that these define a distance between the objective 14a of the microscope 14 and the main platform 18 that is as suitable as possible. By way of example, the support elements could have a height of approximately 20 cm or 40 cm, although other heights are also possible. The actual object region 26 is defined by a height-adjustable microscope stage 34 (laboratory jack) in this exemplary embodiment, the vertical extent of the object region 26 reaching from the object plane 36 to the microscope objective 14a. As a result, great flexibility is achieved for the examination of objects of different sizes.

According to the shown preferred embodiment, the main platform 18 is formed by an optical table 30, which is embodied as an antivibration table. In particular, the optical table 30 may comprise an active and/or passive hydraulic and/or pneumatic damping system in the table legs 32 in order to reduce and/or avoid mechanical action and/or mechanical vibrations on the main platform 18.

In particular, the microscope arrangement 10 according to the shown embodiment can be particularly advantageous for microscopic examination of living animals of different sizes since the object region 26 has a size suitable for also being able to position living animals of different sizes therein and, where necessary, being able to position required peripherals, such as, e.g., laboratory jacks 34 and/or a hot plate and/or a head holder and/or a pulse measuring device or the like, therein.

FIG. 3 schematically shows the coupling of multi-photon laser beams 116a, 116b, 116c into a microscope 14. By way of example, the laser 16a is a mode-coupled titanium-sapphire laser, while the laser 16b could be a mode-coupled titanium-sapphire laser, for example, with an integrated optical parametric oscillator (OPO). Here, some of the titanium-sapphire laser radiation is used to pump the specified OPO in order thus to produce a further wavelength in the infrared range. The Ti:Sa laser radiation 116a is continuously tunable over a large wavelength range (700-1050 nm). The laser beam 116b is Ti:Sa laser radiation, which has a wavelength of 1041 nm, for example, while the laser beam 116c represents the OPO laser radiation, the wavelength of which is 760 nm, for example. The two multi-photon lasers 16a and 16b are synchronized with the aid of electronics.

Using a so-called “delay stage”, denoted by 50, the two laser beams 116b and 116c can either be overlaid in time or shifted relative to one another in time. The telescopes 52 serve to manipulate the beam diameters, the divergences and the focal positions of the individual laser beams 116a, 116b and 116c in such a way that they coincide in the sample in ideal fashion. The elements 40 and 42 are each deflection elements, in this case as a constituent part of the input coupling optical unit. Overall, the input coupling elements comprise at least the deflection elements 40, 42 illustrated here, the delay stage 50 and the telescopes 52. All laser beams 116a, 116b and 116c are coupled into the microscope 14 or the scanning head of the microscope 14 (cf. explanations in relation to FIG. 2) by the input coupling port 44 and are imaged, overlaid in time and space, on the sample.

Once again, 24 denotes the holding element that carries the microscope 14. Shown as a constituent part of the microscope are an eyepiece 46 and a camera port 48 for connecting a highly sensitive camera in the IR or visible spectral range for allowing correct positioning of the sample or for searching for regions on the sample. Once again, 22 denotes the instrument platform and 18 denotes the main platform.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Microscopy arrangement
12 Holding apparatus
14 Microscope
14a Objective
16 Illumination device
16a First laser
16b Second laser
18 Main platform
20 Support element
22 Instrument platform
24 Holding element
26 Object region
28 Cutout
30 Optical table
32 Table legs
34 Microscope stage, laboratory jack
36 Object plane
40 Deflection element
42 Deflection element
44 Input coupling port
46 Eyepiece
48 Camera port
50 Delay stage
52 Telescope
100 Vertical direction
102 Horizontal direction
116a Laser beam
116b Laser beam
116c Laser beam

1. A microscopy arrangement comprising:
a microscope system comprising:
a microscope, and
an illumination device comprising at least two lasers configured to produce laser beams and input coupling elements configured to input couple the laser beams into the microscope, and a holding apparatus comprising:
an instrument platform, on which the at least two lasers of the illumination device are disposed,
a holding element which is rigidly connected, to the instrument platform and to the microscope, and
at least one support element configured to support the instrument platform on a main platform and at a distance from the main platform,
wherein, in a vertical projection, the holding apparatus at least does not completely overlap with the microscope supported by the holding element,
wherein a region between the microscope and the main platform forms an object region, and
wherein at least one of:
the at least one support element has a changeable height such that the instrument platform is positionable at a changeable vertical distance from the main platform, and
a height-changeable microscope stage is configured to dispose an object plane that is defined by the microscope stage at a changeable vertical distance from the main platform such that a vertical extent of the object region is changeable,
whereby the at least two laser beams remain in a fixed relationship with one another in time and/or space, even in a case of a change in the vertical extent of the object region.

2. The microscopy arrangement as claimed in claim 1,
wherein the at least one support element has a changeable height and comprises a drive element configured to change the height of the at least one support element.

3. The microscopy arrangement as claimed in claim 1, wherein the at least one support element is a plurality of support elements.

4. The microscopy arrangement as claimed in claim 1, wherein the main platform is embodied as an anti-vibration table.

5. The microscopy arrangement as claimed in claim 1, wherein the at least two lasers of the illumination device comprise two lasers that are not couplable into the microscope by way of optical fibers.

6. The microscopy arrangement as claimed in claim 1, wherein the microscope stage is disposed on the main platform.

7. A method for examining a sample using the microscope in the microscopy arrangement as claimed in claim 1, the method comprising:
examining the sample following the coupling of each of the laser beams produced by the at least two lasers into the microscope, and
using the adjustments already made for coupling the laser beams into the microscope during a subsequent change in the vertical extent of the object region as a result of changing the height of the at least one support element and/or as a result of changing the vertical distance of the object plane from the main platform by of the height-changeable microscope stage.

8. The method as claimed in claim 7, wherein optical elements with the exception of optical fibers are used as input coupling elements for the at least two lasers.

9. The method as claimed in claim 7, wherein the at least one support element has a given height and is selected from a plurality of support elements of different heights.

10. The method as claimed in claim 7, wherein two lasers that are not couplable into the microscope by way of optical fibers are used as the at least two lasers.

11. The method as claimed in claim 7, wherein an anti-vibration table is used as a main platform.

12. The method as claimed in claim 8, wherein the two lasers are multi-photon lasers.

13. The microscopy arrangement as claimed in claim 5, wherein the two lasers are multi-photon lasers.
